(19) United States
(12) Patent Application Publication
(10) Pub. No.: US 2004/0129562 A1
(43) Pub. Date: Jul. 8, 2004

(54) Low impedance oxygen sensor and associated methods

(76) Inventors: Pavel Shuk, Copley, OH (US); Tom Blanar, Wadsworth, OH (US)

Correspondence Address: WESTMAN, CHAMPLIN & KELLY, A PROFESSIONAL ASSOCIATION, SUITE 1600 - INTERNATIONAL CENTRE, 900 SECOND AVENUE SOUTH, MINNEAPOLIS, MN, 55402-3319, US

(21) Appl. No.: 10/335,970

(22) Filed: Jan. 2, 2003

(51) Int. Cl. G01N 27/26

(52) U.S. Cl. 204/402; 204/424

(57) ABSTRACT

An oxygen sensor includes an electrolytic cell having a solid electrolyte capable of conducting oxygen ions at high temperatures and two electrodes oppositely attached to the electrolyte. The electrodes are generally made of porous, electron-conducting material, typically platinum, stable in high temperature. The electrolytic cell is treated with alternating current (AC) at a relatively high temperature for a period of time. The electrode treatment reduces impedance of the oxygen sensor. The electrode treatment can be used as a step in sensor manufacturing, as part of the warm-up cycle of an operational sensor or as part of a maintenance or repair schedule.

### FIELD OF THE INVENTION

The present invention relates oxygen sensors. More particularly, the present invention relates to an oxygen sensor with improved electrode efficiencies.

### BACKGROUND OF THE INVENTION

High temperature oxygen sensors are well known in the prior art. Conventionally, a high temperature oxygen sensor includes a solid electrolyte, such as stabilized zirconium oxide. This solid electrolyte has an unusual property of conducting oxygen ions (O⁻²) when a certain temperature is reached, typically above 400 degrees Celsius. Generally, as temperature further increases, oxygen ions become more mobile. Hence, the operational temperature of this type of sensor is typically above 650° C. The zirconium oxide electrolyte is typically doped with calcium oxide or yttrium oxide for stability and to further increase mobility of the oxygen ions.

The typical zirconium oxide oxygen sensor includes two electrodes that are attached to the solid electrolyte. The first electrode is exposed to process gas and the second electrode is exposed to reference air of known oxygen content. The process gas is physically isolated from the reference air except through the solid electrolyte. The solid electrolyte is frequently formed as a ceramic cylinder or disk. Both electrodes are generally made of porous, electron-conducting materials, and are typically platinum. A voltmeter or other suitable device is generally coupled to both electrodes with wire leads to complete the circuit.

Typically, a voltage develops when the partial pressure of oxygen in the process gas side differs from the partial pressure of oxygen in the reference air. The partial pressure of a gas such as oxygen corresponds to its concentration in the gas. When there exists an oxygen concentration difference between process gas and reference air, electrons flow through the wire leads to the electrode exposed to the higher relative concentration of oxygen. At this electrode, the oxygen molecules in the gas accept electrons to form oxygen ions. This reaction is known as reduction and the electrode where this occurs is called the cathode. Depending on the particular use, the cathode can be the process electrode or the reference electrode.

The oxygen ions formed at the cathode then flow through the solid electrolyte. The typical solid electrolyte has a crystal structure with vacancies or holes through which the oxygen ions migrate. The oxygen ions flow through the electrolyte to the electrode with the lower oxygen concentration. When the oxygen ions reach this electrode, oxygen and free electrons are released on the electrode. This reaction is known as oxidation and oxidation occurs at the anode. These free electrons again flow though the wire leads to complete the circuit. The anode can be the process electrode or the reference electrode depending on the relative oxygen concentrations of process gas and reference air.

At the anode and cathode, the chemical reactions are as follows:

2O⁻²→O₂+4e⁻ at the anode

2O₂+4e⁻→2O⁻² at the cathode.

The cell output signal is the voltage measured across the electrolyte also known as the electromotive force (EMF) generated by the cell. The measured voltage follows a Nernst-type equation:

$$EMF = \frac{RT}{4 F} ln \frac{P ( {O}_{2} ) reference}{P ( {O}_{2} ) process} + C$$

where

R is the universal gas constant;

T is the absolute temperature;

F is Faraday's constant;

ln is the natural logarithm;

C is the cell constant related to thermal and design effects of cell.

From the above equation, it can be seen that the cell output signal changes logarithmically with the oxygen partial pressure in the process gas stream when the oxygen partial pressure in the reference stream is constant. The maximum detectable oxygen concentration in the process gas is equal to the oxygen concentration in the reference air. At this point, the cell open-circuit voltage will be zero. If the oxygen concentration in the process gas exceeds the oxygen concentration in the reference air, the oxygen ions will move in the opposite direction, and the open-circuit voltage will be of opposite polarity. Also, it is important to maintain constant temperature in the cell. Otherwise, the cell output signal must compensate for variable temperature. Typically, heater coils and a temperature sensor are placed near the cell to maintain constant high temperature.

The proper functioning of the oxygen sensor requires chemical equilibrium at the interface of the electrolyte, electrodes, and gas. Porous electron-conducting electrodes to a large extent help maintain this equilibrium. However, some oxygen sensors may experience increased interface blockage over time. This blockage at the interface results in increased sensor impedance. Another common problem is electrode degradation due to continued exposure to process gas. This degradation also results in increased impedance of the sensor. Increasing sensor impedance negatively affects sensor performance by decreasing its accuracy and increasing its response time.

Therefore, there exists a need for a high temperature oxygen sensor that has lower impedance for better performance. There also exists a need for an cell treatment method to reduce impedance of an oxygen sensor. Embodiments of the present invention provide solutions to these and other problems, and offer other advantages over the prior art.

### SUMMARY OF THE INVENTION

An oxygen sensor includes an electrolytic cell having a solid electrolyte capable of conducting oxygen ions at high temperatures and two electrodes oppositely attached to the electrolyte. The electrodes are generally made of porous, electron-conducting material, typically platinum, stable in high temperature. The electrolytic cell is treated with alternating current (AC) at a relatively high temperature for a period of time. The electrode treatment reduces impedance of the oxygen sensor. The electrode treatment can be used as a step in sensor manufacturing, as part of the warm-up cycle of an operational sensor or as part of a maintenance or repair schedule. Oxygen sensors having treated electrolytic cells have better performance due to their lower impedance when compared with conventional oxygen sensors.

### BRIEF DESCRIPTION OF THE DRAWINGS

FIG. 1 is a diagrammatic view of an environment for an oxygen sensor, such as a combustion process.

FIG. 2 is a diagrammatic view of an oxygen sensor monitoring a process gas or exhaust.

FIG. 3 is a diagrammatic view of a current-type oxygen sensor monitoring a process gas or exhaust.

FIG. 4 is a diagrammatic view of major steps of electrolytic cell treatment of the present invention.

FIG. 5 is a diagrammatic view of an oxygen-sensing transducer having integrated electrolytic cell treatment of present invention.

FIG. 6 is a flow diagram of major steps of an oxygen sensor servicing procedure using cell treatment method of present invention.

FIG. 7 is a diagrammatic view of an apparatus for servicing oxygen sensor using electrolytic cell treatment of present invention.

FIGS. 8-12 are charts illustrating experimental results of oxygen sensors treated in accordance with embodiments of the present invention.

### DETAILED DESCRIPTION OF THE PREFERRED EMBODIMENTS

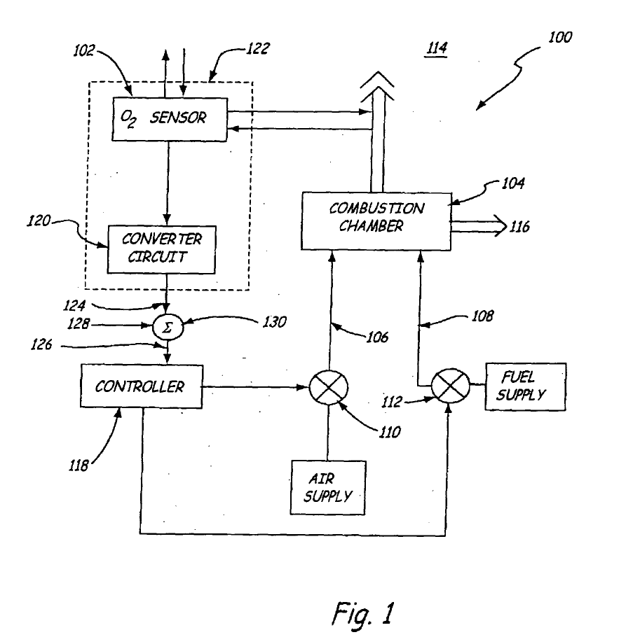

FIG. 1 is a diagrammatic view of a typical environment in which embodiments of the invention are particularly useful.

FIG. 1 shows combustion process 100 having an oxygen sensor 102 of the present invention. Combustion process 100 employs combustion chamber 104 with air input 106 and fuel input 108 controlled by air damper 110 and fuel valve 112 respectively. Combustion process 100 generates an exhaust stream 114 comprising combustion bi-products (or multi-products when combustion is not complete) and air.

Oxygen sensor 102 is fluidically coupled to exhaust stream 114 to measure oxygen concentration and provide an indication thereof to controller 118. Combustion process 100 typically has an oxygen concentration set point 128 designed to optimize combustion process 100. If the oxygen concentration of exhaust stream 114 is below set point 128, incomplete combustion is indicated, often due to inadequate air input 106. Incomplete combustion leads to excess combustibles in the exhaust stream 114. Controller 118 can then respond by adjusting air damper 110 to increase air supply 106.

On the other hand, when oxygen concentration of exhaust stream 114 is above set point 128, complete combustion is indicated. This situation is associated with fewer unburned combustibles in exhaust stream 114, but often accompanied by inadequate energy output. Controller 118 can respond by decreasing air supply 106 or increasing fuel supply 108 as needed for adequate energy output. Combustion process is optimized when oxygen concentration of exhaust stream 114 is equal to set point 128.

Oxygen sensor 102 is typically connected to converter circuit 120 to form transducer 122. Transducer 122 emits transducer output 124 containing oxygen concentration information to controller 118. Controller 118 which includes setpoint 128 responds to error signal 126 by sending an air supply control signal 132 to damper 110. Damper 110 adjusts air supply 106 accordingly. Optionally, controller 118 may respond to error signal 126 by adjusting fuel supply 108.

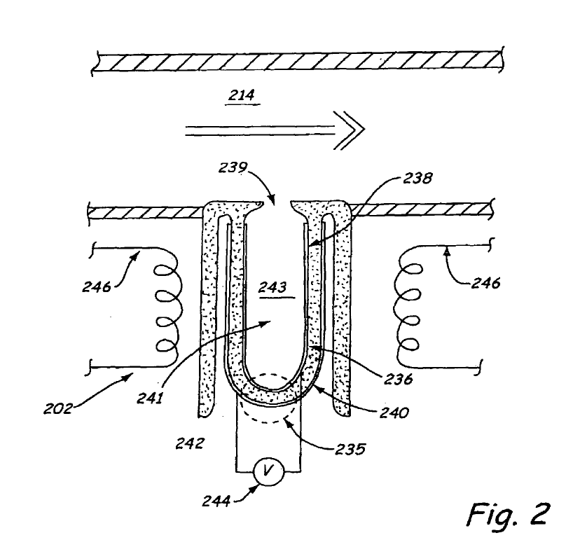

FIG. 2 is a diagrammatic view of oxygen sensor 202 attached to ductwork and exposed to process gas or exhaust stream 214. FIG. 2 is one possible work environment, among others, for oxygen sensor 202. High temperature oxygen sensors can also take the form of cylindrically-shaped probes that extend into a process gas stream or disk-shaped devices that have a low profile relative to the ductwork surface.

Oxygen sensors in accordance with embodiments of the present invention generally have reduced impedance compared to conventional oxygen sensors. Lower impedance is associated with higher accuracy and reliability and generally provides lower response times. One embodiment of the present invention is an oxygen sensor 202 having an electrolytic cell 235 treated by a method in accordance with an embodiment of the present invention to reduce impedance of the oxygen sensor. The method includes short-term application of alternating current at relatively high temperature. Alternating current is applied in the range of about 1 to about 6 volts within temperature range of 650° to 750° C. The frequency of the alternating current can be in the range of about 0.1 Hz to about 10 MHz. Treatment occurs over time period ranging from 1 to 10 minutes. After treatment, electrolytic cell 235 shows an order of magnitude reduction in impedance relative to an untreated cell. The treatment may be repeated as necessary. Lower sensor impedance generally results in better sensor performance, such as better accuracy and faster response time.

In FIG. 2, oxygen sensor 202 is placed in process gas stream 214 to monitor oxygen concentration. Electrolytic cell 235 includes a solid electrolyte 236, a process electrode 238, and a reference electrode 240 disposed on opposite sides of solid electrolyte 236.

Solid electrolyte 236 is capable of conducting oxygen ions at relatively high temperature, typically above 650° Celsius. Typical solid electrolyte materials include zirconium oxide doped for more stability and improved performance. Both process electrode 238 and reference electrode 240 are often porous, electron-conducting metals material, such as platinum, and are stable at relatively high temperatures. Other metallic electrode alternatives include silver (Ag) and palladium (Pd). Also, non-metallic electrodes based on perovskites, such as lanthanum manganite (La_{0.7}Ca_{0.3}MnO₃) or oxide electrodes with a fluorite structure, such as Ce_{0.75}Tb_{0.25}O₂₋ₓ may be appropriate for electrode material.

A voltmeter 244 or other suitable device is electrically connected across the process electrode 238 and reference electrode 240 to measure a voltage generated by the electrolytic cell 235. An optional temperature control system 246 can be used to maintain constant relatively high temperature in the oxygen sensor 102 to ensure proper operation.

Process gas 243 from stream 214 passes through port 239 into cavity 241. Process electrode 238 is exposed to process gas 243. Reference electrode 240 is exposed to reference air 242 having known oxygen content. If the oxygen concentration of process gas 243 and reference air 242 differ, then a voltage is generated that can be measured by voltmeter 244.

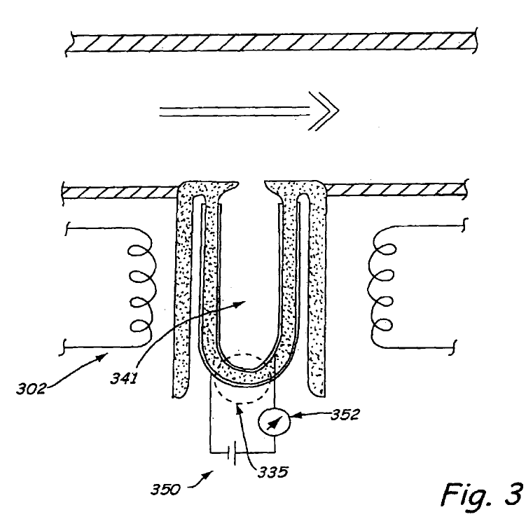

FIG. 3 represents a diagrammatic view of a current-mode alternative to oxygen sensor 202, shown in FIG. 2. In current-mode oxygen sensor 302, direct current (DC) power source 350 and amp meter 352 is connected in series across electrolytic cell 335. DC power source 350 and amp meter 352 are substituted in place of voltmeter 244, shown in FIG. 2. Electrolytic cell 335 is identical to electrolytic cell 235. DC power source 350 applies a small excitation to reduce the oxygen partial pressure in cavity 341 to near zero. Amp meter 352 measures a current indicative of oxygen concentration in process gas.

Current-mode oxygen sensors experience similar impedance problems as voltage-mode oxygen sensors. In the present embodiment, current-mode oxygen sensor 302 includes electrolytic cell 335 treated with a method that is identical to that of electrolyte cell 235.

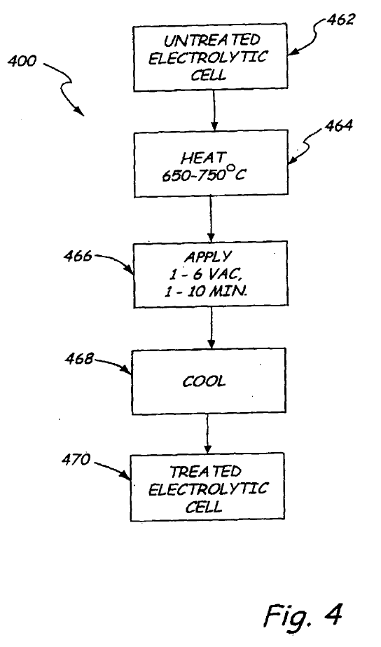

FIG. 4 is a flow diagram of a number of steps for treating electrolytic cells in accordance with embodiments of the present invention. The steps of treatment method 400 are applied to electrolytic cell 235, 335 (shown in FIGS. 2 and 3). Initially, an untreated electrolytic cell is provided as indicated at block 462. Next, a heat source is provided to the electrolytic cell causing its temperature to reach about 650° to about 750° C. as indicated at block 464. Next, an AC power source is provided across the cell as indicated at block 466. Preferably, 1 to 6 volts are applied for a time period of about 1 to about 10 minutes. Optional fourth step 468 provides controlled cooling to the electrolytic cell. Finally, the electrolytic cell is removed from treatment process as indicated at block 470. The treated electrolytic cell can then be assembled into complete oxygen sensor. When an electrolytic cell is treated as set forth above, impedance reductions on the order of 10-20 times (approximately 90-95% reduction) can be achieved.

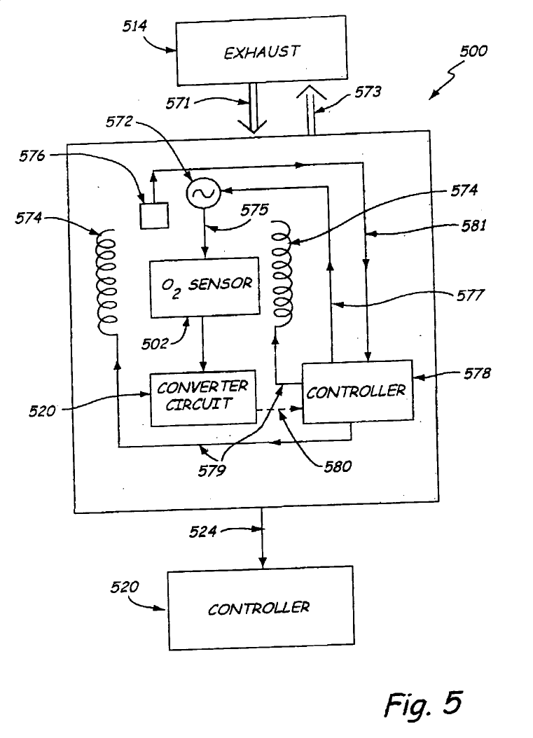

FIG. 5 illustrates an embodiment of an oxygen-sensing transducer comprising an oxygen sensor having a warm-up cycle with integrated cell treatment. Electrode treatment may be integrated into the warm-up cycle of either an oxygen sensor or an oxygen-sensing transducer. As discussed above, zirconium oxide and similar oxygen sensors operate at relatively high temperature. Therefore, these oxygen sensors are typically integrated with a temperature sensor, and heat source, and controller that cooperate to maintain constant high temperature or to measure temperature. In one embodiment, oxygen sensor 502 is designed to complete cell treatment every time the sensor is turned on. An oxygen sensor having a warm-up cycle with integrated cell treatment results in an oxygen sensor much less likely to develop high impedance over time.

Transducer 500 monitors oxygen concentration in exhaust stream 514. Transducer 500 includes oxygen sensor 502 that senses oxygen concentration in process gas. Transducer 500 further includes converter circuit 520 for converting sensor output 501 to transducer output 524. Converter circuit 520 may generate transducer output 524. Alternately, converter circuit 520 may output converter signal 580 to transducer controller 578. In this case, controller 578 produces transducer output 524 to main controller 526.

Process gas from exhaust stream 514 enters at transducer inlet 571 and exits at outlet 573. Heaters 574, temperature sensor 576, and controller 578 cooperate to maintain constant high temperature during both warm-up electrode treatment and operation. During the warm up cycle of transducer 500, controller 578 outputs heat control signal 579 to heaters 574. Heaters 574 provide heat to oxygen sensor 502 to increase its temperature to an approximate range of 650° to 750° C. Temperature may be fixed or adjustable depending on system design. Temperature sensor 576 senses temperature and produces output 581 indicative of temperature to controller 578. Controller 578 responds with appropriate control signal 579 to heaters 574 to increase or decrease heat as needed.

AC power source 572 is connected across oxygen sensor 502 to provide an AC signal, preferably having an amplitude of about 1 to 6 volts of alternating current during cell treatment. Applied alternating current may be fixed or adjustable depending on system design. During warm-up, AC power source 572 turns on after receiving AC control signal 577 from controller 578. AC power source turns off after about 1 to about 10 minutes. The time period may be fixed or adjustable depending on system design. AC power source 572 is operational only during the warm up cycle.

When transducer 500 is activated, temperature control system (574, 576, 578) is also activated. Temperature control system (574, 576, 578) maintains constant high temperature needed for proper sensor operation. Proper operational temperature of sensor 502 varies depending on design criteria. However, operating temperature of sensor 502 is typically 700-800° C. Therefore, temperature control system (574, 576, 578) preferably is capable of maintaining more than one relatively high temperature so that cell of sensor 502 may be treated with impedance lowering method at one relatively high temperature (approximately 650° to 750° Celsius) during warm-up. Sensor 502 can operate at even higher temperatures (above 800° Celsius) after warm-up is completed.

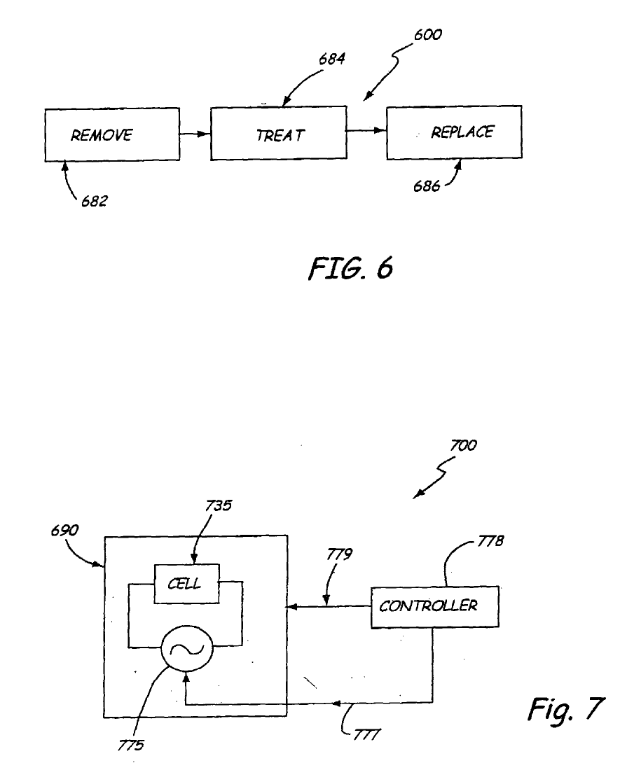

FIG. 6 is a flow diagram of method 600 for maintaining or repairing oxygen sensors utilizing electrode treatment in accordance with an embodiment of the present invention. As stated above, over time an oxygen sensor can develop higher impedance due to a blocked interface or electrode degradation. In cases of a blocked interface, an oxygen sensor may be serviced by the electrode treatment of the present invention. Method 600 includes removing the oxygen sensor from monitoring environment, as indicated at block 682. The oxygen sensor is treated by impedance reducing electrolytic cell treatment as set forth above in accordance with embodiments of the present invention, as indicated at block 684. Finally, the sensor is reinstalled into its monitoring environment as indicated at block 686.

FIG. 7 illustrates apparatus 700 for maintaining or repairing oxygen sensors. Electrolytic cell 702 is placed in oven 690. As discussed previously an electrolytic cell comprises a solid electrolyte, electrodes, and optional wire leads. AC power source 775 is connected across electrolytic cell 702. AC power source 775 and oven 690 are connected to controller 778. Controller 778 sends heat control signal 779 to oven 690 to provide relatively high temperature environment. Controller 778 sends AC control signal 777 to AC power source 775 to provide AC. Apparatus 700 may comprise a timer and/or temperature sensor (not shown). The apparatus 700 may comprise an impedance monitor (not shown) capable of monitoring cell impedance.

Laboratory results are included in FIGS. 8-12. FIG. 8 shows the impedance change of an electrolytic cell having platinum electrodes and a solid electrolyte (Pt/Solid Electrolyte/Pt cell) after AC treatment at 650° Celsius. The initial impedance range is 450-1500 Ω and after treatment the range is 20-60 Ω. FIG. 9 shows the impedance change of a Pt/Solid Electrolyte/Pt cell after 5 minutes of AC treatment. FIG. 10 shows the impedance change of a treated Pt/Solid Electrolyte/Pt cell during 200 hours of stabilization. FIG. 11 shows the impedance change of an electrolytic cell having electrodes comprising La_{0.7}Ca_{0.3}MnO₃. FIG. 12 shows the impedance change of an electrolytic cell having electrodes comprising Ce_{0.75}Tb_{0.25}O₂₋ₓ.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed.

What is claimed is:

1. A method of treating an electrolytic cell to reduce impedance comprising:
heating the electrolytic cell to a selected temperature; and
providing alternating current across the electrolytic cell to treat the cell.

2. The method of claim 1 wherein the alternating current has an amplitude of more than about 1 volt.

3. The method of claim 2 wherein the alternating current has an amplitude of at most 6 volts.

4. The method of claim 1 wherein the temperature is at least 650° Celsius.

5. The method of claim 4 wherein the temperature is at most 1000° Celsius.

6. The method of claim 1 wherein the time period is at least 1 minute.

7. The method of claim 6 wherein the time period is at most 10 minutes.

8. An oxygen sensor treated according to the method of claim 1.

9. The sensor of claim 8, wherein:
the electrolytic cell comprises a solid electrolyte capable of conducting oxygen ions; and
two electrodes disposed on the electrolyte.

10. The oxygen sensor of claim 9, further comprising a voltmeter electrically coupled across the electrolytic cell.

11. The oxygen sensor of claim 9, further comprising a direct current power source and ampmeter electrically coupled in series across the electrolytic cell.

12. The oxygen sensor of claim 9 wherein the solid electrolyte comprises zirconium oxide.

13. The oxygen sensor of claim 12 wherein the zirconium oxide is doped.

14. The oxygen sensor of claim 9 wherein the electrodes are constructed from platinum.

15. The oxygen sensor of claim 9 wherein the electrodes are constructed from La_{0.7}Ca_{0.3}MnO₃ or any other perovskite type material.

16. The oxygen sensor of claim 9 wherein the electrodes are constructed from Ce_{0.75}Tb_{0.25}O₂₋ₓ or any other mixed conducting fluorite type material.

17. A transducer for providing an output related to oxygen concentration in a sample stream, the transducer comprising:
an oxygen sensor including a solid electrolyte and a plurality of electrodes disposed on opposite sides of the solid electrolyte, wherein one of the plurality of electrodes is fluidically couplable to the sample stream, and another of the plurality of electrodes is fluidically coupled to a reference gas having a known oxygen concentration;
measurement circuitry coupled to the oxygen sensor to provide an oxygen signal based upon an electrical characteristic of the oxygen sensor;
a thermal control system thermally coupled to the oxygen sensor to heat the oxygen sensor to at least one elevated temperature;
a controller coupled to the measurement circuitry and the thermal control system, the controller being adapted to set the thermal control system to at least one setpoint, and further adapted to receive the oxygen signal from an oxygen concentration output based on the oxygen signal;
an alternating current (AC) source coupled to the controller and disposed to generate an alternating current through the oxygen sensor; and
wherein the controller is adapted to provide a warm-up state wherein the thermal control system maintains the oxygen sensor at a selected temperature and wherein the AC source generates the alternating current though the oxygen sensor.

18. The transducer of claim 17 wherein the controller is adapted to end the warm-up state and enter an operational state wherein the AC source does not generate alternating current through the oxygen sensor.

19. The transducer of claim 18, wherein the controller cause the thermal control system to maintain the oxygen sensor at a temperature higher than the selected temperature of the warm-up state, during the operational state.

20. A method of servicing an electrolytic cell of an oxygen sensor to lower sensor impedance, the method comprising:
providing a high temperature environment for the cell; and
providing an alternating current across the cell for a selected period of time.

21. An apparatus for servicing an electrolytic cell of an oxygen sensor, the apparatus comprising:
a heat source capable of providing high temperature to the electrolytic cell; and
an AC power source capable of providing alternating current to the electrolytic cell for a selected period of time.
